(19) United States
(12) Patent Application Publication
(10) Pub. No.: US 2016/0019277 A1
(43) Pub. Date: Jan. 21, 2016

(54) METHOD OF CROSS REFERENCING INFORMATION RELATING TO A MOBILE OPERATOR AND INFORMATION RELATING TO A THIRD-PARTY BASE AND SERVER ADAPTED FOR IMPLEMENTING THIS METHOD

(71) Applicant: DHATIM SARL, Palaiseau (FR)

(72) Inventors: Pierre DE CHASTELLIER, Paris (FR); Thomas BOURGEOIS, Clamart (FR)

(73) Assignee: DHATIM SARL, PALAISEAU (FR)

(21) Appl. No.: 14/768,185

(22) PCT Filed: Jan. 29, 2014
(86) PCT No.: PCT/EP2014/051708

§ 371 Date: Aug. 14, 2015

(30) Foreign Application Priority Data
Feb. 22, 2013 (FR) 1351554

(51) Int. Cl. G06F 17/30; H04M 15/00

(52) U.S. Cl. CPC G06F 17/30575; G06F 17/30563; H04M 15/41

(57) ABSTRACT

A method is provided for cross referencing information relating to communication service operations of an operator implementing mobile terminals with data stored in a third-party base relating to the management of the mobile terminals. The method includes a replication of the third-party database, a detection of changes that have occurred in the third-party database, and a production of job-related rules pertaining to the terminals so as to decide a real-time deactivation/reactivation of the service.

### TECHNICAL FIELD

The present invention relates to a method for the reconciliation of information relating to a mobile operator and information relating to a third-party base. It also relates to a server adapted for implementing this method.

### STATE OF THE PRIOR ART

In a telecommunications network, a telecommunications operator can subscribe to communication service operations. This subscription must be carried out individually for each terminal connected to the operator. The operator is billed for each terminal having thus subscribed to such a service. Similarly, ending this subscription is also done individually.

Consequently, the failure to end this subscription to communication service operations for a terminal that is not connected to the operator can involve the operator being billed unnecessarily, and the improper use of network resources.

Indeed, depending on the communication service operations, this subscription should only be in place on the basis of a set of validated conditions.

The purpose of the present invention is to solve at least one of these problems posed by the state of the art.

### DISCLOSURE OF THE INVENTION

Such an objective is achieved with a method for reconciling information relating to communication service operations of a mobile operator implementing mobile terminals with data relating to the management of said mobile terminals stored in a third-party base, characterized in that it comprises a replication of said third-party database, a detection of changes that have taken place in said third-party database, and a production of business-related rules relating to said terminals.

The information relating to communication operations of a mobile operator is for example information generated and recorded by a mobile telephone operator.

The data stored in a third-party database relating to the management of the terminals is for example information generated and recorded by a communication services supplier.

In addition, the business-related rules can comprise a procedure for extracting transactions from the third-party database and copying said transactions into a reconciliation database.

In addition, the business-related rules can comprise a procedure for processing a transaction received from the third-party database and updating the status of the mobile terminal concerned in the third-party database.

In addition, the business-related rules can also comprise receiving status information on mobile phones originating from an interface dedicated to interacting with the third-party database. Advantageously, the business-related rules can also comprise retrieving status information on mobile phones originating from an interface dedicated to interaction with the third-party database.

In addition, the method according to the invention can also comprise importing data relating to billing services associated with said mobile terminals.

In addition, the method according to the invention can also comprise importing prepaid transactions implemented by a service operator.

In addition, the method according to the invention can also comprise receiving data generated by a program stored on a memory of a SIM card of the terminal relating to mobile communication devices.

In addition, the method according to the invention can also comprise supplying reconciliation information.

In addition, the method according to the invention can also comprise exporting statistics on new and destroyed mobile terminals.

In addition, the method according to the invention can also comprise providing a warning of improper use of an account dedicated to interaction with the third-party database.

In addition, the method according to the invention can also comprise dynamic synchronization of user accounts in response to detection of a modification or of an event on mobile terminals.

According to another aspect of the invention, a server is proposed adapted for reconciling information relating to communication service operations of a mobile operator implementing mobile terminals with data stored in a third-party base relating to the management of said mobile terminals, characterized in that it comprises means for replicating said third-party database in a reconciliation base, means for detecting changes that have occurred in said third-party database, and means for producing business-related rules for the service operations of said mobile terminals.

### DESCRIPTION OF THE FIGURES AND EMBODIMENTS

Other advantages and characteristics of the invention will become apparent on examination of the detailed description of an embodiment which is in no way limitative, and the attached diagram, in which:

FIG. 1 shows an embodiment of the method according to the invention.

As this embodiment is in no way limitative, variants of the invention can be considered comprising only a selection of the characteristics described hereinafter, in isolation from the other characteristics described (even if this selection is isolated within a phrase containing other characteristics), if this selection of characteristics is sufficient to confer a technical advantage or to differentiate the invention with respect to the state of the art. This selection comprises at least one, preferably functional, characteristic without structural details, or with only a part of the structural details if this part alone is sufficient to confer a technical advantage or to differentiate the invention with respect to the state of the prior art.

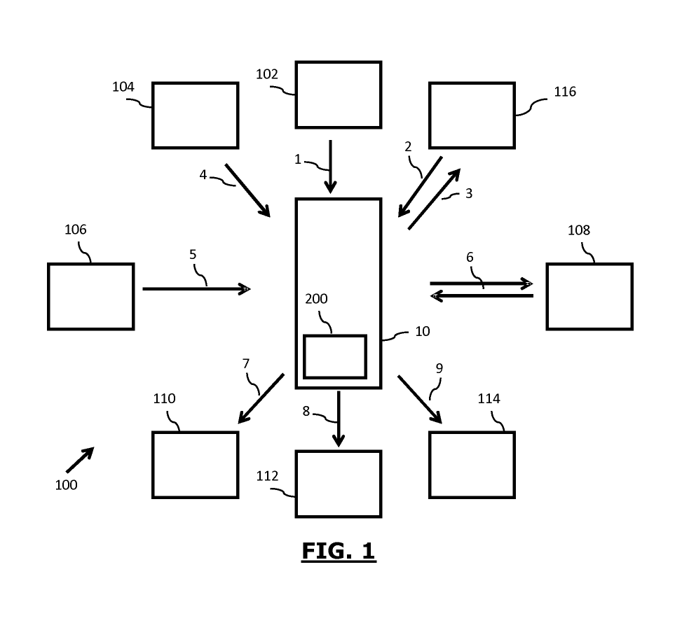

There will now be described, with reference to FIG. 1, a method 100 for reconciling information relating to communications service operations of a service operator implementing mobile terminals with data stored in a third-party database 102 relating to the management of said mobile terminals.

The method 100 comprises:
a replication 1 of the third-party database 102,
a detection of changes that have occurred in said third-party database 102, and
a production of business-related rules relating to said terminals.

The replication 1 of the third-party database 102 comprises importing all the transactions of all the accounts stored in the third-party database 102.

This importing is carried out by emulating a human interaction with a web site and by emulating the latter so as to retrieve all the transactions in an HTML format.

The business-related rules then comprise a procedure for the extraction of transactions from the third-party database 102. They also comprise a procedure for copying transactions into a reconciliation database 200.

In certain specific cases, the business-related rules also comprise a procedure for processing a transaction received from the third-party database 102 and updating 3 of the status 116 of the mobile terminal concerned in the third-party database 102. The updating 3 of the status 116 results in the real-time deactivation or reactivation of the communication service.

The business-related rules also comprise receiving information 2 from the service operator of the status 116 of mobile telephones originating from an interface dedicated to interacting with the third-party database 102.

The business-related rules also comprise retrieving information from these mobile phone statuses originating from the dedicated interface.

Indeed, the transactions imported in step 1 may not be sufficient to know everything about the mobile phones, particularly when the mobile phone is a new user of the third-party service or when transactions have been deleted from the third-party database 102. This interface can be queried by a web query means. It can also be queried by an XML query means. XML query means are created by using the SOAP protocol (Simple Object Access Protocol)

The method 100 also comprises importing 4 data 104 relating to the billing of services associated with said mobile terminals.

The method 100 also comprises importing 5 prepaid transactions 106 implemented by a service operator.

The method 100 also comprises receiving 6 data generated by a program stored on a memory of a SIM card 108 of the terminal relating to mobile communication devices. The data are generated by the mobile terminal because the latter has received beforehand an event monitoring program which was saved on its SIM card.

Receiving 6 data generated by the program stored on the memory of the SIM card 108 is carried out by receiving an SMS. The event monitoring program is also sent in SMS form according to OTA (“Over the Air”) technology.

The method 100 also comprises supplying 7 reconciliation information 110. A web interface is generated to provide a display of reconciliation information 110 but also to allow search within this reconciliation information 110.

The method 100 also comprises exporting 8 statistics 112 on mobile terminals that are new, destroyed or unable to use the communication service operations. These statistics are daily. Of course, another time frequency is possible. The statistics are generated by an operator. They are sent by email. Of course, other means of notification of these statistics are possible.

The method 100 also comprises providing a warning 9 of improper use 114 of an account dedicated to interacting with the third-party database 102. Detection of an improper use 114 of a user account is carried out using a list of authorized users (“white list”). In this case, any attempt to make use of a user account other than one recorded in the white list is considered by the method 100 as an attempt at improper use 114. Of course, the implementation of a list of improper users (“black list”) is also possible.

The method 100 also comprises a dynamic synchronization 10 of user accounts in response to the detection of a modification or an event on mobile terminals.

This detection can be a detection of a new terminal. It can also be the detection of a SIM event 108 received, a missing transaction or also a failure of synchronization when too much time has elapsed.

Of course, the invention is not limited to the examples which have just been described and numerous adjustments can be made to these examples without exceeding the scope of the invention.

1. A method for reconciling information relating to communication service operations of a mobile operator implementing mobile terminals with data stored in a third-party base relating to the management of said mobile terminals, comprising: a replication of said third-party database; a detection of changes that have occurred in said third-party database; and a production of business-related rules relating to said terminals.

2. The method according to claim 1, characterized in that the business-related rules comprise a procedure for extracting transactions from the third-party database and copying said transactions into a reconciliation database.

3. The method according to claim 1, characterized in that the business-related rules comprise a procedure for processing a transaction received from the third-party database and updating the status of the mobile terminal concerned in the third-party database.

4. The method according to claim 1, characterized in that the business-related rules also comprise receiving information from the service operator on the status of mobile phones originating from an interface dedicated to interacting with a third-party database.

5. The method according to claim 1, characterized in that it also comprises importing data relating to billing services associated with said mobile terminals.

6. The method according to claim 1, characterized in that it also comprises importing prepaid transactions implemented by a service operator.

7. The method according to claim 1, characterized in that it also comprises receiving data generated by a program stored in a memory of a SIM card of the terminal relating to mobile communication devices.

8. The method according to claim 1, characterized in that it also comprises supplying reconciliation information.

9. The method according to claim 1, characterized in that it also comprises exporting statistics on the new and destroyed mobile terminals.

10. The method according to claim 1, characterized in that it also comprises providing a warning of improper use of a user account dedicated to interacting with the third-party database.

11. The method according to claim 1, characterized in that it also comprises dynamic synchronization of user accounts in response to a detection of a modification or an event on mobile terminals.

12. A server configured for reconciling information relating to communication service operations of a mobile operator implementing mobile terminals with data stored in a third-party database relating to the management of said mobile terminals, comprising: means for replicating said third-party database in a reconciliation base; means for detecting changes that have occurred in said third-party database; and means for producing business-related rules for the service operations of said mobile terminals.
